(19) United States
(12) Patent Application Publication
(10) Pub. No.: US 2012/0106336 A1
(43) Pub. Date: May 3, 2012

(54) DATA COMMUNICATION SYSTEM AND COMMUNICATION CONTROL METHOD THEREOF

(75) Inventor: Youn-sub HAN, Changwon-city (KR)

(73) Assignee: SAMSUNG TECHWIN CO., LTD., Changwon-city (KR)

(21) Appl. No.: 13/286,636

(22) Filed: Nov. 1, 2011

(30) Foreign Application Priority Data
Nov. 1, 2010 (KR) 10-2010-0107716

(51) Int. Cl. H04W 28/10

(52) U.S. Cl. 370/230.1

(57) ABSTRACT

A data communication system and a communication control method are provided. The data communication system includes a data transmission apparatus and a data receiving apparatus connected to each other through two or more parallel paths; and two or more routers disposed on the two or more parallel paths, respectively, wherein at least one of the routers detects bandwidth aggregation communication being performed on the parallel paths, from data transmitted through the at least one of the routers, and controls a sum of transmission rates used for the bandwidth aggregation communication to be lower than an upper-limit transmission rate during the bandwidth aggregation communication.

### CROSS-REFERENCE TO RELATED PATENT APPLICATION

This application claims priority from Korean Patent Application No. 10-2010-0107716, filed on Nov. 1, 2010, in the Korean Intellectual Property Office, the disclosure of which is incorporated herein in its entirety by reference.

### BACKGROUND

1. Field

Apparatuses and methods consistent with exemplary embodiments relate to data communication and communication control, and more particularly, to a data communication system including parallel paths between a data transmission apparatus and a data receiving apparatus and a communication control method.

2. Description of the Related Art

To apply a bandwidth aggregation transmission protocol, such as the stream control transmission protocol (SCTP) developed by the Internet Engineering Task Force (IETF), parallel paths may be formed between a data transmission apparatus and a data receiving apparatus.

Specifically, when a data communication system uses the bandwidth aggregation transmission protocol, parallel paths, other than a single path, are used for bandwidth aggregation. Thus, when the data communication system uses the bandwidth aggregation transmission protocol along with another transmission protocol, a communication performed based on the other transmission protocol may suffer an obstacle caused by bandwidth aggregation communication performed based on the bandwidth aggregation transmission protocol.

For example, when image data are transmitted from a security camera to a monitoring computer, a wired communication and a wireless communication may be simultaneously used. Here, if the bandwidth aggregation communication is applied to the wireless communication, the wired communication may not be performed properly due to the wireless communication.

### SUMMARY

Exemplary embodiments provide a data communication system and a communication control method that prevent a communication using a transmission protocol other than a bandwidth aggregation transmission protocol from suffering an obstacle caused by a bandwidth aggregation communication using the bandwidth aggregation transmission protocol when the data communication system and the communication control method use the transmission protocol along with the bandwidth aggregation transmission protocol.

According to an aspect of an exemplary embodiment, there is provided a data communication system including a data transmission apparatus; a data receiving apparatus connected to the data transmission apparatus through two or more parallel paths; and two or more routers disposed on the two or more parallel paths, respectively, wherein at least one of the routers detects bandwidth aggregation communication being performed on the parallel paths, from data transmitted through the at least one of the routers, and controls a sum of transmission rates used for the bandwidth aggregation communication to be lower than an upper-limit transmission rate during the bandwidth aggregation communication.

The at least one of the transmission routers may include: a bandwidth-aggregation detecting unit, a transmission-rate measuring unit, an upper-limit transmission-rate calculating unit, and a bandwidth control unit.

The bandwidth-aggregation detecting unit may detect the bandwidth aggregation communication.

The transmission-rate measuring unit may, if the bandwidth-aggregation detecting unit detects the bandwidth aggregation communication, measure the sum of the transmission rates by communicating with other transmission routers.

The upper-limit transmission-rate calculating unit may multiply a set increase ratio to a highest transmission rate among the transmission rates and alculate the upper-limit transmission rate.

The bandwidth control unit may control the sum of the transmission rates to be lower than the upper-limit transmission rate.

Information regarding the highest transmission rate may be provided from the transmission-rate measuring unit to the upper-limit transmission-rate calculating unit.

If the sum of the transmission rates is equal to or greater than the upper-limit transmission rate, the bandwidth control unit may reduce the transmission rates by using a set attenuation rate.

The bandwidth control unit may multiply the set attenuation rate to each of the transmission rates, and provide each of the other transmission routers with a corresponding resultant transmission rate value as a corresponding appropriate transmission rate so that each of the other transmission routers operates at the corresponding appropriate transmission rate.

According to an aspect of another exemplary embodiment, there is provided a communication control method performed by a data communication system including a data transmission apparatus and a data receiving apparatus connected to each other through two or more parallel paths on which two or more routers are disposed, respectively.

The communication control method may detect bandwidth aggregation communication being performed on the parallel paths, from data transmitted through the at least one of the transmission routers.

The communication control method may control a sum of transmission rates used for the bandwidth aggregation communication to be lower than an upper-limit transmission rate during the bandwidth aggregation communication.

The controlling of the sum of the transmission rates may include: if the bandwidth aggregation communication is detected, measuring the sum of the transmission rates.

The controlling of the sum of the transmission rates may further include: multiplying a set increase ratio to a highest transmission rate among the transmission rates and calculating the upper-limit transmission rate.

The controlling of the sum of the transmission rates may further include: controlling the sum of the transmission rates to be lower than the upper-limit transmission rate.

The controlling the sum of the transmission rates to be lower than the upper-limit transmission rate may include reducing the transmission rates by using a set attenuation rate.

The reducing the transmission rates may include: multiplying the set attenuation rate to each of the transmission rates, and providing each of the other transmission routers with a corresponding resultant transmission rate value as a corresponding appropriate transmission rate so that each of the other transmission routers operates at the corresponding appropriate transmission rate.

According to an aspect of still another exemplary embodiment, there is provided a data communication device including: a detection unit which detects a characteristic of communication being performed through two or more paths disposed between a transmitter and a receiver; and a control unit which measures transmission rates used for the bandwidth aggregation communication and controls a sum of the transmission rates to be lower than a given value, if the detection unit determines the detected characteristic as indicating at least a bandwidth aggregation communication.

According to an aspect of still another exemplary embodiment, there is provided a transmitter which is connected to a receiver and may include: a measuring unit which measures transmission rates used for a bandwidth aggregation communication being performed through two or more paths disposed between the transmitter and the receiver, when the bandwidth aggregation communication is being performed according to a bandwidth aggregation transmission protocol along with a different communication according to a different protocol through the two or more paths; and a control unit which controls a sum of the transmission rates used for the bandwidth aggregation communication to be lower than a given value while the bandwidth aggregation communication and the different communication are being performed through the two or more paths.

### BRIEF DESCRIPTION OF THE DRAWINGS

The above and other aspects will become more apparent by describing in detail exemplary embodiments thereof with reference to the attached drawings, in which:

FIG. 1 is a block diagram of a data communication system according to an exemplary embodiment;

FIG. 2 is a flowchart of a bandwidth control method performed by a bandwidth control unit of FIG. 1, according to an exemplary embodiment;

FIG. 3 is a diagram for explaining communication between a transmission router and a receiving router of FIG. 1 to start a data transmission based on a bandwidth aggregation transmission protocol, according to an exemplary embodiment;

FIG. 4 is a diagram for explaining communication between a transmission router and a receiving router of FIG. 1 during a data transmission process based on a bandwidth aggregation transmission protocol, according to an exemplary embodiment; and

FIG. 5 is a diagram for explaining communication between a transmission router and a receiving router of FIG. 1 to end a data transmission based on a bandwidth aggregation transmission protocol, according to an exemplary embodiment.

### DETAILED DESCRIPTION OF EXEMPLARY EMBODIMENTS

The inventive concept will now be described more fully with reference to the accompanying drawings, in which exemplary embodiments of the invention are shown. The inventive concept may, however, be embodied in many different forms and should not be construed as being limited to the exemplary embodiments set forth herein. Rather, these exemplary embodiments are provided so that this disclosure will be thorough and complete, and will fully convey the inventive concept to those skilled in the art.

As used herein, the term “and/or” includes any and all combinations of one or more of the associated listed items. Expressions such as “at least one of,” when preceding a list of elements, modify the entire list of elements and do not modify the individual elements of the list.

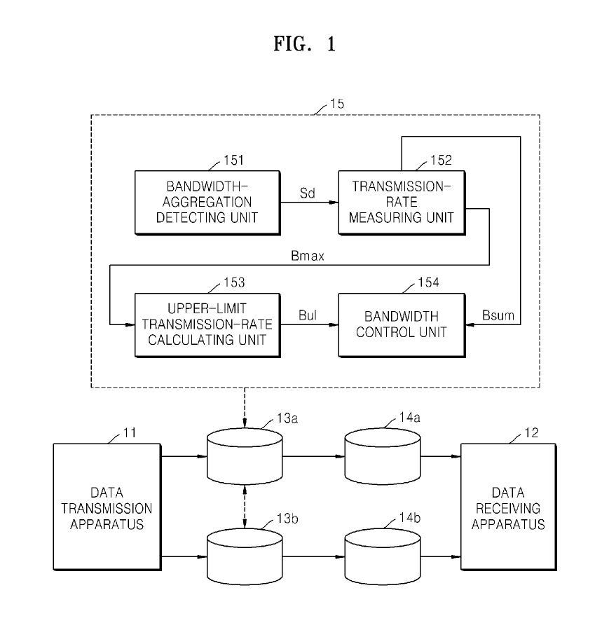

FIG. 1 is a block diagram of a data communication system according to an exemplary embodiment. Referring to FIG. 1, the data communication system of the present exemplary embodiment includes parallel paths between a data transmission apparatus 11 and a data receiving apparatus 12. Although two parallel paths are formed in the present exemplary embodiment, three or more parallel paths may be formed. In the present exemplary embodiment, one transmission router 13a or 13b and one receiving router 14a or 14b are used per parallel path. However, more than one transmission router 13a or 13b, and more than one receiving router 14a or 14b may be used per parallel path.

According to an exemplary embodiment, at least one of the transmission routers 13a and 13b detects bandwidth aggregation communication being performed according to a bandwidth aggregation transmission protocol from data transmitted through the transmission routers 13a and 13b. The at least one of the transmission routers 13a and 13b controls a sum of transmission rates in the parallel path, that is, the bandwidth aggregation communication paths, to be lower than an upper-limit transmission rate while communicating with the other routers during the bandwidth aggregation communication.

Therefore, when the data communication system in FIG. 1 uses a bandwidth aggregation transmission protocol along with a transmission protocol other than the bandwidth aggregation transmission protocol, the data communication system may prevent a communication using the other transmission protocol from suffering an obstacle caused by a communication using the bandwidth aggregation transmission protocol.

The data communication system in FIG. 1 shows a bandwidth control module 15 included in at least one of the transmission routers 13a and 13b, according to an exemplary embodiment.

That is, the bandwidth control module includes a bandwidth-aggregation detecting unit 151, a transmission-rate measuring unit 152, an upper-limit transmission-rate calculating unit 153, and a bandwidth control unit 154.

The bandwidth-aggregation detecting unit 151 detects bandwidth aggregation communication being performed and inputs a detection signal Sd indicating such detection into the transmission-rate measuring unit 152.

The transmission-rate measuring unit 152 receives the detection signal Sd from the bandwidth-aggregation detecting unit 151, and measures a sum Bsum of transmission rates in the bandwidth aggregation communication paths while communicating with the other transmission routers for the bandwidth aggregation communication. The measured sum Bsum of transmission rates is provided to the bandwidth control unit 154.

The transmission-rate measuring unit 152 provides the upper-limit transmission-rate calculating unit 153 with a value of a highest transmission rate Bmax among the transmission rates in bandwidth aggregation communication paths.

The upper-limit transmission-rate calculating unit 153 multiplies a set increase ratio GA to the highest transmission rate Bmax and calculates an upper-limit transmission rate Bul that is a resultant value.

The bandwidth control unit 154 controls the transmission routers 13a and 13b to reduce transmission rates in the parallel paths so that the sum Bsum of transmission rates measured by the transmission-rate measuring unit 152 to be lower than the upper-limit transmission rate Bul calculated by the upper-limit transmission-rate calculating unit 153.

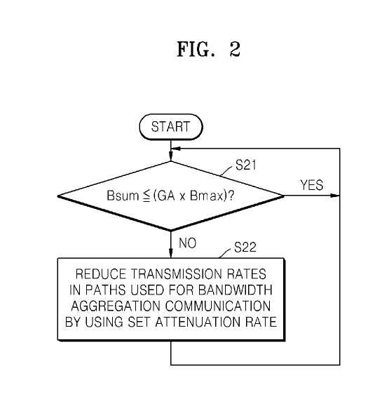

FIG. 2 is a flowchart of a bandwidth control method performed by the bandwidth control unit 154 of FIG. 1, according to an exemplary embodiment. Referring to FIGS. 1 and 2, the bandwidth control unit 154 controls the sum Bsum of transmission rates measured by the transmission-rate measuring unit 152 to be lower than the upper-limit transmission rate Bul calculated by the upper-limit transmission-rate calculating unit 153.

In this regard, the upper-limit transmission rate Bul is a value (GA×Bmax) obtained by multiplying the set increase ratio GA to the highest transmission rate Bmax among the transmission rates in the bandwidth aggregation communication paths.

The set increase ratio GA is greater than “1” and may be different according to a communication environment. In the present exemplary embodiment, the set increase ratio GA is determined as “1.5”.

If the sum Bsum of transmission rates measured by the transmission-rate measuring unit 152 is equal to or greater than the upper-limit transmission rate Bul calculated by the upper-limit transmission-rate calculating unit 153 (operation S21), the bandwidth control unit 154 reduces transmission rates in the paths used for bandwidth aggregation communication by using a set attenuation rate (operation S22). In the present exemplary embodiment, the set attenuation rate is 90%. That is, in operation S22, the transmission rate in the paths used for bandwidth aggregation communication is 90%.

In this regard, the bandwidth control unit 154 multiplies the set attenuation rate, for example, 90%, to each of the transmission rates in the paths used for bandwidth aggregation communication, and, if the bandwidth control module 15 is included only in the transmission router 13a, the bandwidth control unit 154 provides the transmission router 13b with a corresponding resultant transmission rate value as an appropriate transmission rate, so that the transmission router 13b operates at the appropriate transmission rate. The bandwidth control unit 154 also controls the transmission router 13a including the bandwidth control unit 154 to operate at a corresponding resultant transmission rate as an appropriate transmission rate. Here, the corresponding resultant rates for the transmission routers 13a and 13b may not be the same since each of the transmission rates for each of the paths measured by the transmission rate measuring unit 152 may not be the same.

According to an exemplary embodiment, if each of the transmission routers 13a and 13b has the bandwidth control module 15, the transmission-rate measuring unit 152 of each bandwidth control module 15 measures a transmission rate of a corresponding path of the parallel paths, shares information on the transmission rate with the other bandwidth control module 15, and controls the sum Bsum of the transmission rates to be lower than the upper-limit transmission-rate Bul which is calculated by the upper-limit transmission-rate calculating unit 153 of at least one of the two bandwidth control modules 15 respectively included in the transmission routers 13a and 13b. More specifically, the upper-limit transmission rate Bul is calculated by the upper-limit transmission-rate calculating unit 153 of at least one of the two bandwidth control modules 15, and, if the sum Bsum is equal to or greater than the upper-limit transmission rate Bul, the bandwidth control unit 154 of each of the two bandwidth control modules 15 reduces the corresponding transmission rate of the corresponding path in the parallel paths using the set attenuation rate 90%.

According to an exemplary embodiment, the bandwidth control unit 154 may apply the attenuation rate 90% to the sum Bsum of transmission rates instead of each of the transmission rates in the parallel paths, unlike the previous exemplary embodiment in which the attenuation rate 90% is applied to each of the transmission rates. In this manner, the bandwidth control unit 154 may control only the transmission router 13b of the two transmission routers 13a and 13b in the parallel paths to reduce the corresponding transmission rate as long as the sum Bsum of transmission rates is reduced by 10%.

According to an exemplary embodiment, the transmission routers 13a and 13b and the receiving routers 14a and 14b in FIG. 1 may be internal components of the data transmission apparatus 11 and the data receiving apparatus 12, respectively.

According to an exemplary embodiment, the bandwidth control module 15 is not included in the at least one of the transmission routers 13a and 13b, and instead, is an independent device as even not being included in the data transmission apparatus 11.

According to an exemplary embodiment, each path of the parallel paths may have only one router to control transmission rates of the parallel paths, or only one of the parallel paths may have a router to control the transmission rates of the parallel paths.

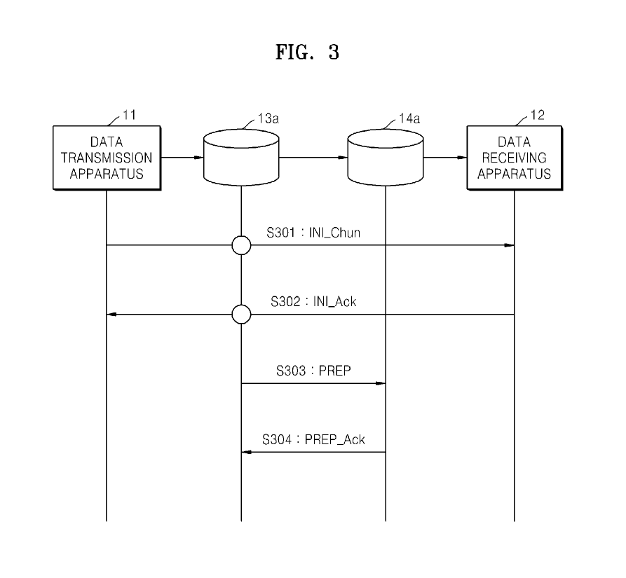

FIG. 3 is a diagram for explaining communication between the transmission router 13a and the receiving router 14a of FIG. 1 to start a data transmission based on the bandwidth aggregation transmission protocol in the parallel paths, i.e., the bandwidth aggregation communication paths, as shown in FIG. 1, according to an exemplary embodiment. For simplicity of explanation, only one single path constituting the parallel path is shown in FIG. 3.

Although two routers 13a and 14a in a single path are shown in FIG. 3, if there are three or more routers in a single path, all routers between the two routers 13a and 14a simultaneously perform functions of a transmission router and a receiving router.

The same reference numerals of FIG. 3 as shown in FIG. 1 denote the same elements. Referring to FIG. 3, to start the data transmission based on the bandwidth aggregation transmission protocol, operations of communicating between the transmission router 13a and the receiving router 14a of FIG. 1 will now be described below.

The data transmission apparatus 11 transmits an initial signal chunk INI_Chun to the data receiving apparatus 12 through parallel paths to start bandwidth aggregation communication, for example, a stream control transmission protocol (SCTP) communication (operation S301).

In this regard, the transmission router 13a detects the initial signal chunk INI_Chun, and obtains a transmission port number and a transmission Internet protocol (IP) address of the data transmission apparatus 11 for the initial signal chunk INI_Chun.

Thus, the data receiving apparatus 12 transmits an initial signal acknowledgement chunk INI_Ack to the data transmission apparatus 11 (operation S302).

In this regard, the transmission router 13a detects the initial signal acknowledgement chunk INI_Ack and obtains a receiving port number and a receiving IP address of the data transmission apparatus 11 for the initial signal acknowledgement chunk INI_Ack.

The transmission router 13a transmits communication preparation data PREP including the obtained transmission port number, transmission IP address, receiving port number, and receiving IP address in the data transmission apparatus 11 to the receiving router 14a (operation S303).

The receiving router 14a transmits an acknowledgement signal of the communication preparation data PREP to the transmission router 13a (operation S304).

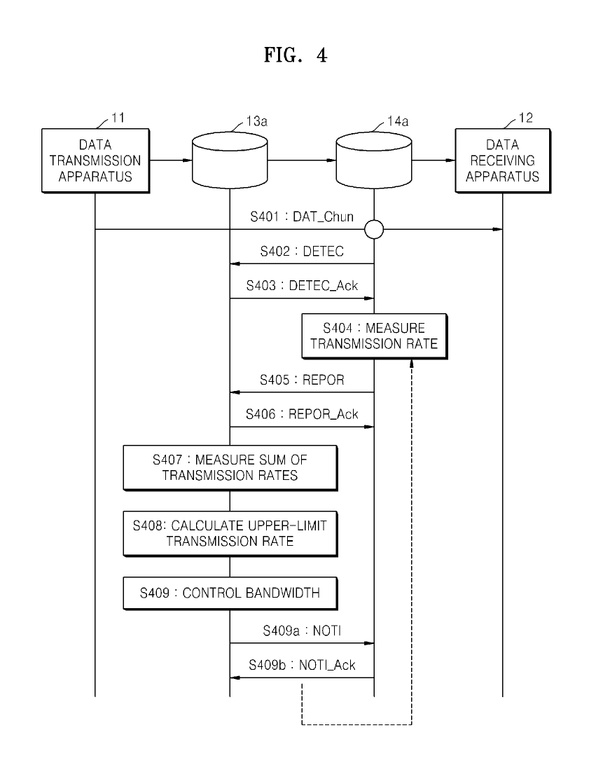

FIG. 4 is a diagram for explaining communication between the transmission router 13a and the receiving router 14a of FIG. 1 during a data transmission process based on the bandwidth aggregation transmission protocol in the parallel paths, i.e., the bandwidth aggregation communication paths, as shown in FIG. 1, according to an exemplary embodiment. The same reference numerals of FIG. 4 as shown in FIGS. 1 and 3 denote the same elements. Referring to FIG. 4, during the data transmission process based on the bandwidth aggregation transmission protocol, operations of communicating between the transmission router 13a and the receiving router 14a of FIG. 1 will now be described below. For simplicity of explanation, only one single path constituting the parallel path is shown in FIG. 4.

The data transmission apparatus 11 transmits a data chunk DAT_Chun according to bandwidth aggregation communication to the data receiving apparatus 12 through the parallel paths (operation S401).

The receiving apparatus 14a transmits a data chunk detection signal DETEC to the transmission router 13a (operation S402).

The transmission router 13a transmits a detection acknowledgement signal DETEC_Ack to the receiving router 14a (operation S403).

The receiving router 14a measures a transmission rate of its own path (operation S404), and transmits transmission rate report data REPOR to the transmission router 13a (operation S405).

The transmission router 13a transmits a report acknowledgement signal REPORT_ACK to the receiving router 14a (operation S406), and then measures the sum Bsum of transmission rates in the bandwidth aggregation communication paths while communicating with the other transmission routers (operation S407).

The transmission router 13a multiplies the set increase ratio GA to the highest transmission rate Bmax among the transmission rates in the bandwidth aggregation communication paths and calculates the upper-limit transmission rate Bul that is a resultant value (operation S408, see FIG. 2).

The transmission router 13a controls the sum Bsum of transmission rates in the bandwidth aggregation communication paths to be lower than the upper-limit transmission rate Bul (operation S409, see FIG. 2).

In more detail, if the sum Bsum of transmission rates is equal to or greater than the upper-limit transmission rate Bul, the transmission router 13a multiplies a set attenuation rate, for example, 90%, to each of the transmission rates in the paths used for bandwidth aggregation communication, and provides the receiving router 14a and the other transmission routers with corresponding resultant transmission rate values as corresponding appropriate transmission rates (operations S409, S409a, and S409b)

Thus, the other transmission routers and/or receiving routers may operate at the corresponding appropriate transmission rates.

In operation S409a, NOT1 denotes information of the appropriate transmission rate in a corresponding path provided to the receiving router 14a from the transmission router 13a.

In operation S409b, NOT1_Ack denotes a transmission rate acknowledgement signal provided from the receiving router 14a to the transmission router 13a.

Operations S404 through S409b are repeatedly performed until the data transmission ends.

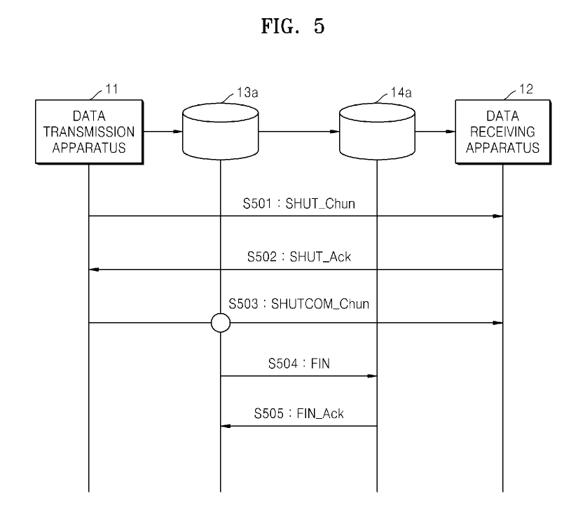

FIG. 5 is a diagram for explaining communication between the transmission router 13a and the receiving router 14a of FIG. 1 to end a data transmission based on the bandwidth aggregation transmission protocol in the parallel paths, i.e., the bandwidth aggregation communication paths, as shown in FIG. 1, according to an exemplary embodiment. The same reference numerals of FIG. 5 as shown in FIGS. 1, 3, and 4 denote the same elements. Referring to FIG. 5, to end the data transmission based on the bandwidth aggregation transmission protocol, operations of communicating between the transmission router 13a and the receiving router 14a of FIG. 1 will now be described below. For simplicity of explanation, only one single path constituting the parallel path is shown in FIG. 5.

The data transmission apparatus 11 transmits an end signal chunk SHUT_Chun to the data receiving apparatus 12 through the parallel paths to end the bandwidth aggregation communication, for example, an SCTP communication (operation S501).

The data receiving apparatus 12 transmits an end signal acknowledgement chunk SHUT_Ack to the data transmission apparatus 11 (operation S502).

The data transmission apparatus 11 transmits a final end signal chunk SHUTCOM_Chun to the data receiving apparatus 12 through the parallel paths (operation S503).

The transmission router 13a detects the final end signal chunk SHUTCOM_Chun, and transmits a communication end signal FIN to the data receiving apparatus 12 (operation S504).

The data receiving apparatus 12 transmits a communication end acknowledgement signal FIN_Ack to the data transmission apparatus 11 (operation S505).

The transmission router 13a and the receiving router 14a may stop a transmission rate control operation in the bandwidth aggregation communication through operations S504 and S505.

As described above, according to the exemplary embodiments, at least one of a plurality of transmission routers installed in parallel paths detects bandwidth aggregation communication being performed therein, and control a sum of transmission rates in the parallel paths, that is, bandwidth aggregation communication paths, to be lower than an upper-limit transmission rate during bandwidth aggregation communication while communicating with the other routers.

Therefore, when the data communication system in FIG. 1 uses a bandwidth aggregation transmission protocol along with a transmission protocol other than the bandwidth aggregation transmission protocol, the data communication system and the communication control method may prevent a communication using the other transmission protocol from suffering an obstacle caused by a communication using the bandwidth aggregation transmission protocol.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A data communication system comprising:
a data transmission apparatus;
a data receiving apparatus connected to the data transmission apparatus through two or more parallel paths; and
two or more routers disposed on the two or more parallel paths, respectively,
wherein at least one of the routers detects bandwidth aggregation communication being performed on the parallel paths, from data transmitted through the at least one of the routers, and controls a sum of transmission rates used for the bandwidth aggregation communication to be lower than an upper-limit transmission rate during the bandwidth aggregation communication.

2. The data communication system of claim 1, wherein the at least one of the transmission routers comprises:
a bandwidth-aggregation detecting unit which detects the bandwidth aggregation communication;
a transmission-rate measuring unit which, if the bandwidth-aggregation detecting unit detects the bandwidth aggregation communication, measures the sum of the transmission rates by communicating with the other transmission routers;
an upper-limit transmission-rate calculating unit which multiplies a set increase ratio to a highest transmission rate among the transmission rates and calculates the upper-limit transmission rate; and
a bandwidth control unit which controls the sum of the transmission rates to be lower than the upper-limit transmission rate.

3. The data communication system of claim 2, wherein, if the sum of the transmission rates is equal to or greater than the upper-limit transmission rate, the bandwidth control unit reduces the transmission rates by using a set attenuation rate.

4. The data communication system of claim 3, wherein the bandwidth control unit multiplies the set attenuation rate to each of the transmission rates, and provides each of the other transmission routers with a corresponding resultant transmission rate value as a corresponding appropriate transmission rate so that each of the other transmission routers operates at the corresponding appropriate transmission rate.

5. A communication control method performed by a data communication system comprising a data transmission apparatus and a data receiving apparatus connected to each other through two or more parallel paths on which two or more routers are disposed, respectively, the method comprising:
detecting bandwidth aggregation communication being performed on the parallel paths, from data transmitted through the at least one of the routers; and
controlling a sum of transmission rates used for the bandwidth aggregation communication to be lower than an upper-limit transmission rate during the bandwidth aggregation communication.

6. The communication control method of claim 5, wherein the controlling of the sum of the transmission rates comprises:
if the bandwidth aggregation communication is detected, measuring the sum of the transmission rates;
multiplying a set increase ratio to a highest transmission rate among the transmission rates and calculating the upper-limit transmission rate; and
controlling the sum of the transmission rates to be lower than the upper-limit transmission rate.

7. The communication control method of claim 6, wherein the controlling the sum of the transmission rates comprises, if the sum of the transmission rates is equal to or greater than the upper-limit transmission rate, reducing the transmission rates by using a set attenuation rate.

8. The communication control method of claim 7, wherein the reducing the transmission rates comprises multiplying the set attenuation rate to each of the transmission rates, and providing each of the other transmission routers with a corresponding resultant transmission rate value as a corresponding appropriate transmission rate so that each of the other transmission routers operates at the corresponding appropriate transmission rate.

9. A data communication device comprising:
a detection unit which detects a characteristic of communication being performed through two or more paths disposed between a transmitter and a receiver;
a control unit which measures transmission rates used for the bandwidth aggregation communication and controls a sum of the transmission rates to be lower than a given value, if the detection unit determines the detected characteristic as indicating at least a bandwidth aggregation communication.

10. The data communication device of claim 9, wherein each of the transmission rates is a transmission rate at each of the two or more paths, and
wherein, if the detection unit determines the detected characteristic as indicating at least the bandwidth aggregation communication, the control unit reduces each of the transmission rates using a set attenuation rate.

11. The data communication device of claim 9, wherein each of the transmission rates is a transmission rate at each of the two or more paths, and
wherein, if the detection unit determines the detected characteristic as indicating at least the bandwidth aggregation communication, the control unit controls the transmitter to reduce at least one of the transmission rates using a set attenuation rate.

12. The data communication device of claim 9, wherein the data communication device is a router which is directly connected to the terminal and controls data communication from the terminal to the receiver.

13. The data communication device of claim 9, wherein the bandwidth aggregate communication is performed based on a stream control transmission protocol.

14. The data communication device of claim 9, wherein the control unit measures transmission rates used for the bandwidth aggregation communication and controls the sum of the transmission rates to be lower than the given value, if the detection unit determines the detected characteristic as indicating the bandwidth aggregation communication performed based on a bandwidth aggregation transmission protocol and another communication performed based on a different protocol.

15. The data communication device of claim 14, wherein each of the transmission rates is a transmission rate of each of the two or more paths, and
wherein, if the detection unit determines the detected characteristic as indicating the bandwidth aggregation communication performed based on the bandwidth aggregation transmission protocol and the other communication performed based on the different protocol, the control unit reduces each of the transmission rates using a set attenuation rate.

16. The data communication device of claim 14, wherein each of the transmission rates is a transmission rate of each of the two or more paths, and
wherein, if the detection unit determines the detected characteristic as indicating the bandwidth aggregation communication performed based on the bandwidth aggregation transmission protocol and the other communication performed based on the different protocol, the control unit controls the transmitter to reduce at least one of the transmission rates using a set attenuation rate.

17. The data communication device of claim 14, wherein the data communication device is a router directly connected to the terminal and controlling data communication from the terminal to the receiver.

18. The data communication device of claim 14, wherein the bandwidth aggregate communication is performed based on a stream control transmission protocol.

19. The data communication device of claim 14, wherein the bandwidth aggregate communication is a wireless communication, and the other communication is a wired communication.

20. A transmitter connected to a receiver, the transmitter comprising:
a measuring unit which measures transmission rates used for a bandwidth aggregation communication being performed through two or more paths disposed between the transmitter and the receiver, when the bandwidth aggregation communication is being performed according to a bandwidth aggregation transmission protocol along with a different communication according to a different protocol through the two or more paths;
a control unit which controls a sum of the transmission rates used for the bandwidth aggregation communication to be lower than a given value while the bandwidth aggregation communication and the different communication are being performed through the two or more paths.

21. The transmitter of claim 20, wherein the bandwidth aggregate communication is a wireless communication, and the other communication is a wired communication.
